(19) United States
(12) Patent Application Publication
(10) Pub. No.: US 2006/0077871 A1
(43) Pub. Date: Apr. 13, 2006

(54) Optical recording medium

(75) Inventors: Noriko Inoue, Kanagawa (JP); Hiroaki Takano, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/203,222

(22) Filed: Aug. 15, 2005

(30) Foreign Application Priority Data
Sep. 14, 2004 (JP) 2004-266696

(51) Int. Cl. G11B 7/24

(52) U.S. Cl. 369/275.1

(57) ABSTRACT

Disclosed is an optical recording medium with a uniform optical information recording layer that resists deformation, thereby attaining excellent recording and reproducing characteristics, great productivity, and handling ease. This optical recording medium includes two light transmitting substrates, and an optical information recording layer to which information is to be recorded with recording light and which is formed between the light transmitting substrates. Moreover, a thickness of the optical information recording layer is at least 100 μm, the Young's modulus of the optical information recording layer ranges from 1000 MPa to 30000 MPa, and each of the light transmitting substrates has a thickness ranging from 50 μm to 1500 μm.

### BACKGROUND OF THE INVENTION

1. Field of the Invention

The present invention relates to an optical recording medium. More specifically, the present invention is directed to an optical recording medium to which information is to be recorded in three dimensions, such as a multi-layered optical memory or a holographic memory.

2. Description of the Related Art

As current examples of optical recording media that are commercialized presently or are about to be commercialized, CD-Rs, digital versatile discs (DVDs), blue-ray discs and other various media are known. The recording capacity of these media is currently up to 27 GB. However, the capacity of information to be communicated is increasing rapidly in today's information age society. Therefore, it has been in demand that optical recording media with much larger recording capacity appear. Current models of high recording capacity media are holographic memories, multi-layered optical memories, and optical recording media using near-field light. These models are being developed as new generation optical recording media.

Typically, such optical recording media have an optical information recording layer made of an optical recording material, and information is stored in this layer. As for holographic memories, information is recorded not only on the surface of their optical information recording layer but also throughout the interior. In other words, information is recorded to the optical information recording layer in three dimensions. Information is recorded to the same portion of the layer multiple times, thereby achieving higher density recording or great capacity recording (see Japanese Unexamined Patent Application Publications H6-43634 and H2-3082). Similarly, as to multi-layered optical memories, information is also recorded to their laminated optical information recording layers in three dimensions.

Such optical recording media to which information is recorded in three dimensions require a thick optical information recording layer. This thickness may be as large as 1 mm or more in some cases. In optical recording media which has a thick layer and to which information is to be recorded in three dimensions, the way in which an optical information recording layer is made uniform is a critical matter. Specifically, as to the holographic memory, a large amount of data is recorded/reproduced thereto or thereof all at once. Therefore, if the optical information recording layer is uneven, then the recording and reproducing characteristics may be degraded. Similarly, in multi-layered optical memories, an uneven optical information recording layer may cause the deterioration of the recording and reproducing characteristics.

In addition, if an optical information recording layer is easy to deform, then its surface cannot be made uniform. In terms of handling, it is preferable that an optical information recording layer is hard to deform.

Taking the above descriptions into account, the present invention has been conceived. An object of the present invention is to provide optical recording media with a uniform optical information recording layer that resists deformation, thereby attaining excellent recording and reproducing characteristics, great productivity, and handling ease.

### SUMMARY OF THE INVENTION

According to an aspect of the present invention, there is provided, an optical recording medium including:

(1) two light transmitting substrates; and

(2) an optical information recording layer to which information is to be recorded with recording light and which is formed between the light transmitting substrates, a thickness of the optical information recording layer being at least 100 μm, the Young's modulus of the optical information recording layer ranging from 1000 MPa to 30000 MPa.

In this optical recording medium, the optical information recording layer is hard to deform, thanks to its Young's modulus of 1000 MPa to 30000 MPa.

Accordingly, this optical recording medium enables of keeping the thickness of its optical information recording layer constant. As a result, it is possible to improve its recording and reproducing characteristics and its handling. Also, its productivity is enhanced, thereby reducing the cost.

Other aspects, features and advantages of the present invention will become apparent upon reading the following specification and claims when taken in conjunction with the accompanying drawings.

### BRIEF DESCRIPTION OF THE DRAWINGS

For more complete understanding of the present invention and the advantages hereof, reference is now made to the following description taken in conjunction with the accompanying drawings wherein:

FIG. 1 is a schematic perspective view depicting an optical recording medium according to one embodiment of the present invention;

FIG. 2 is a schematic sectional view depicting the optical recording medium; and

FIG. 3 is a view showing a measurement system of diffraction efficiency.

### DETAILED DESCRIPTION OF THE EXEMPLARY EMBODIMENTS OF THE INVENTION

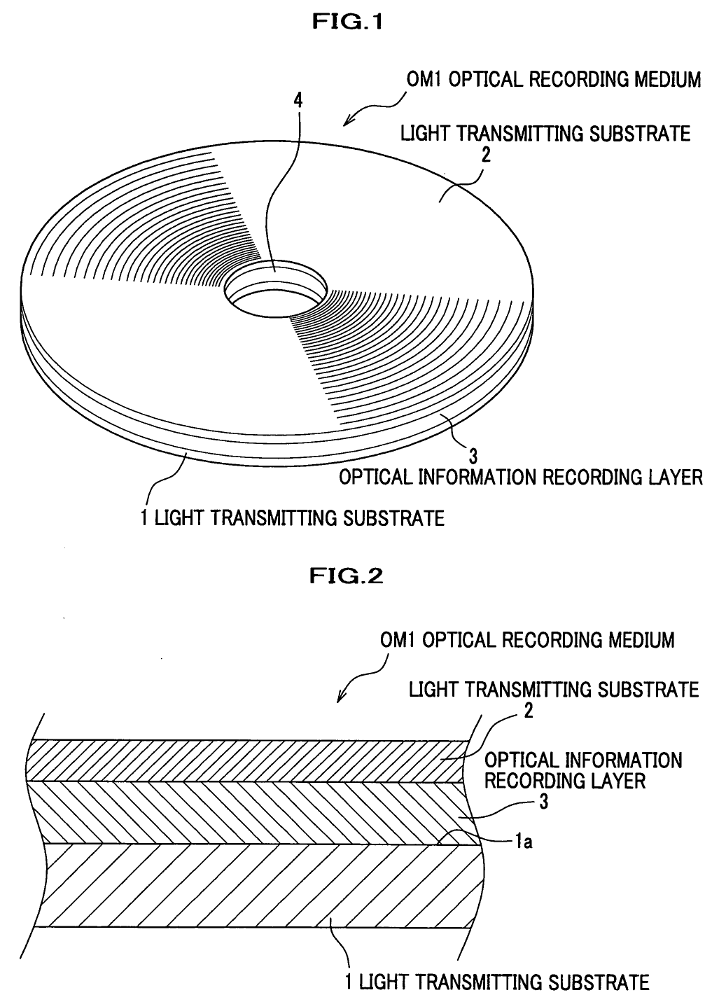

A detail description will be given below, of one embodiment of the present invention, with reference to attached figures. Referring to FIG. 1, an optical recording medium OM1 has a laminated disc form, and it includes light transmitting substrates 1 and 2, an optical information recording layer 3 sandwiched by the substrates 1 and 2 (see FIG. 2), and a hole 4 at its center. The hole 4 is used to rotate the optical recording medium OM1 by a drive mechanism (not shown), upon recording/reproducing of information through hologram.

Each of the light transmitting substrates 1 and 2 may be a film or sheet made of, but not limited to, a natural or synthetic resin or inorganic substance. Examples of the materials making up the light transmitting substances 1 and 2 include an inorganic substance such as glass, and a synthetic resin such as polycarbonate (hereinafter, called “PC”), triacetyl-cellulose (hereinafter, called “TAC”), cycloolefin polymer, polyethylene terephthalate (thereinafter, called “PET”), polyphenylene sulfide (thereinafter, called “PPS”), acrylate resin, methacrylic resin, polystyrene resin, vinyl chloride resin, epoxy resin, polyester resin, and amorphous polyolefin. Among them, PC (polycarbonate) is most preferable in terms of low double refraction. The light transmitting substrates 1 and 2 may be made of either the same material or different materials.

On the surface 1a (see FIG. 2) of the light transmitting substrate 1 which is in contact with the optical information recording layer 3, a reflection layer may be formed. This reflection layer may be formed of one or more elements of Au, Ag, Al, Pt, Cu, Ni, Si, Ge and Cr by means of the sputtering technique.

The light transmitting substrates 1 and 2 are relatively thick, for example, equal to/more than 50 μm thick, more preferably 50 to 1500 μm thick in terms of stiffness upon handling. Especially, it is preferable that the light transmitting substrates 1 and 2 are equal to/more than 200 μm and 50 μm thick, respectively. Recording light is irradiated on the optical recording medium OM1 from where the light transmitting substrate 2 faces. Accordingly, if the light transmitting substrate 2 is made thin, then the scattering of the light, that is, noise due to the substrate is reduced.

Moreover, the following physical matters may be formed beforehand on the surface of the light transmitting substrate 1 which is in contact with optical information recording layer 3;
1) pre-format patterns indicating information regarding servo control such as tracking servo or focus servo, or information for identifying the address of the optical information recording layer, and
2) pits for creating servo signal recording area.

Due to the above physical matter, moire fringes generated by the interference between the monitor light and information light are made precise, so that optical information is recorded more correctly. Also, the optical reproduction by using the monitor light can be performed more correctly. The information recorded on the servo signal recording area is reproduced by using light with a wavelength of equal to/longer than 600 nm. The light of this wavelength is not absorbed into the material of the optical information recording layer 3. Furthermore, a protection layer for shutting out oxygen or moisture may be formed on the optical information recording layer 3.

The material of the optical information recording layer 3 changes its optical characteristics, when the recording light is irradiated thereon. Specifically, its refractivity, transmittance, permittivity, reflectivity or absorptivity changes, depending on whether or not the patterns of the moire fringes formed by the recording light are dark or bright.

The thickness of the optical information recording layer 3 is equal to/more than 100 μm, preferably 100 μm to 2 mm, more preferably 500 μm to 1.5 mm. This thickness range enables the high density or great capacity three-dimension optical recording in a holographic memory or the like.

The optical information recording layer 3 has the Young's modulus of 1000 to 30000 MPa, preferably 2000 to 20000 MPa. Because of this Young's modulus range, the optical information recording layer 3 can hard to deform, thereby keeping its thickness uniform. In addition, its recording and reproducing characteristics, handling ease and productivity can be improved. Thus, its cost can also be reduced.

A typical holographic memory may be made of silver halide, bichromated gelatin, photorefractive material, photochromic material, photopolymer and other materials. Among them, photopolymer is most preferable, because it exhibits high diffraction efficiency, low noise, and excellent storage stability as long as being fixed completely. The typical compositions of photopolymer are binder, polymerizable monomer, sensitizing dye, and polymerization initiator.

It is preferable that the refractivity of the binder and the polymerizable monomer that are both contained in the photopolymer is different from each other. Upon optical recording, moire fringes are created in the optical information recording layer 3. Subsequently, the sensitizing dye is excited on the bright patterns of the moire fringes, thus emitting electrons. The emitted electrons travel to the polymerization initiator, and radicals are then generated. The generated radicals travel to the polymerizable monomer, initiating polymerization. Note that some polymerizable monomers cause polymerization due to acid generator. As a result, the areas on the bright patterns are rich in the polymerizable monomer, and the areas on the dark patterns are rich in the binder. In this way, the refractivity differs in accordance with the bright and dark patterns of the moire fringes. By making use of this refractivity difference, optical information is recorded to the optical recording layer. The polymerizable monomer that has not been used to record the information is exposed with the light of a laser or a white light source, and it is then fixed. Some other monomers are fixed with a thermal treatment.

It is preferable that the binder has a high transmittance and a low double refraction. The concrete examples of the binder include: the copolymer of chlorinated polyethylene, poly methyl methacrylate or methyl methacrylate and (meta)acrylic alkyl ester; the copolymer of chloroethene and acrylonitrile; polyvinyl acetate, polyvinyl alcohol, polyvinyl formal, polyvinyl butyral, polyvinyl pyrrolidone, ethyl cellulose, accetylcellulose, and polycarbonate.

Upon use of the photopolymer, information is recorded due to the refractivity difference between the binder and the monomer. Therefore, the monomer of suitable refractivity needs to be used. Polymerization monomer is not limited a specific material as long as containing a polymerizable polarization group. For example, radical polymerizable monomer, cationic polymerizable monomer or the mixture thereof may be used. Specifically, compounds consisting molecules with a polarization group such as an epoxy group or an unsaturated ethylene group may be used. Accordingly, polymerizable monomer having at least one polarization group in its molecule is used. If it has at least two polarization groups, then these groups may differ from each other or may be the same.

The sensitizing dye preferably has peak absorptivity at the wavelength of the recording light, and the dye contained within has a low light absorptivity constant ε at the wavelength of the recording light. The examples of the sensitizing dye include a known organic or complex dye including cyan, merocyanine, phthalocyan, azo, azomethine, indoaniline, xanthene, coumarin, polymethine, diallyl ethylene, fulgide fluoranthene, anthraquinone and styryl.

The polymerization initiator is thermally inert at equal to/less than 80° C., and it is not limited to a specific material as long as generating appropriate free radicals. It is preferable that an acid generator is used if cationic polymerizable monomer is selected.

The optical recording material may contain, other than the above components, components used typically for forming optical information recording layers of optical recording media, such as sensitizer, optical brightening agent, UV light sorbent, heat stabilizer, chain transfer agent, elasticizer and stain.

Furthermore, the optical recording material may be an optical recording material containing dye for causing refractivity modulation, optical reactant for developing or fading the dye, sensitizing dye for clearing the optical reactant, and binder. This material causes refractivity modulation where the dye is developed or faded, thereby achieving hologram recording.

Any material other than the above ingredients may be used as the optical recording material, as long as its physical property, such as refractivity or transmittance, changes in accordance with the bright and dark patterns of the moire fringes. Moreover, their mixtures may be used, such as a mixture of the eye and the photopolymer or a mixture of the photorefractive material and the photopolymer.

Among them, the optical recording material is most appropriate to a material of the optical information recording layer 3. Use of this optical recording composition makes it possible to form the optical information recording layer 3 with the Young's modulus of 1000 to 30000 MPa easily. By adding filler, elasticizer, blowing agent or curing agent into the optical recording material, its Young's modulus is adjusted to fall within the above-described range. Examples of the filler include organic or inorganic fine particles. Examples of the organic fine particles include acrylic styrene resin powder, polylefins resin powder, melamine resin powder, polyamide resin powder, polyimide resin powder, and polyethylene fluoride resin powder. Examples of the inorganic fine particles include: metal oxide, such as titanium oxide, silicon oxide, zinc oxide, aluminum oxide, antimony oxide, chromium oxide, cerium oxide, yttrium oxide, zirconium oxide, tin oxide, copper oxide, iron oxide, magnesium oxide, manganese oxide, holmium oxide, bismuth oxide, cobalt oxide, erbiumoxide, gadolinium oxide, indiumoxide, nickel oxide, strontium oxide or ytterbium oxide; dielectric fine particles such as silicon nitride, titanium nitride, zirconium nitride, niobium nitride, silicon carbide, titanium carbide, olybdenum carbide or tungsten carbide; a semiconductor consisting of a IV family element such as Si or Ge; a semiconductor consisting of a II-VI family compound such as CdS, CdSe, ZnSe, CdTe, ZnS, HgS and HgSe; a semiconductor consisting of a III-V family compound such as GaAs, InP or InSb; a semiconductor consisting of a IV-VI family compound such as PbS or PbSe; and metal fine particles such as gold, silver, copper, nickel, aluminum, iron, cobalt, tungsten, molybdenum or niobium. In addition, it is preferable that the filler is made of a material that does not absorb the recording light, or of which particle diameter does not absorb the recording light.

The optical recording medium OM1 has a disc-shape. However, the shape of an optical recording medium is not limited to a disc shape, and it may be a card, small chip, box or tape shape. To give an alternative example, an optical recording medium may be a card-shaped optical recording medium by laminating the light transmitting substrate 1, optical information recording layer 3 and light transmitting substrate 3 in this order. In this case, the reflection and protection layers may be formed between the light transmitting substrate 1 and optical information recording layer 3 and between the optical information recording layer 3 and light transmitting substrate 2, respectively. This medium needs to have the Young's modulus of 1000 to 3000 MPa. As it is enlarged, its capacity increases.

This embodiment has been described by exemplifying a holographic recording optical recording medium, but the present invention is not limited thereto. Alternatively, the present invention can be applied to other various three-dimensional optical recording media, including a multi-layered optical memory using two-photon absorption (TPA). Moreover, the present invention can be applied to security cards or imaging media other than optical recording media. It is obvious that the embodiment is applicable to security cards or imaging media.

The optical recording medium OM1 can be fabricated by laminating the light transmitting substrate 1, optical information recording layer 3, and light transmitting substrate 2 in this order. This fabricating process includes: for example, the step of preparing the light transmitting substrates 1 and 2 that each have been molded to a predetermined shape; the step of forming the optical information recording layer 3 by coating the optical recording material on the surface of the light transmitting substrate 1; and the step of sticking the light transmitting substrate 2 on the optical information recording layer. An alternative process includes: the step of laminating the light transmitting substrate 1, optical information recording layer 3, and light transmitting substrate 2 in this order, and the step of forming them to a predetermined shape with a stamping or cut treatment. Naturally, the optical recording medium can be formed to a predetermined shape, such as card or disc shape, depending on its application.

The process in which the optical information recording layer 3 is formed on the light transmitting substrate 1 may be a multi-layer coating, injection molding, thermo compression bonding or a spin coat process.

In the multi-layer coating process, a coating liquid containing the optical recording material is applied to the light transmitting substrate 1, and it is then dried. The above steps are repeated several times. Finally, the optical information recording layer 3 of a predetermined thickness can be formed.

To prepare the coating liquid containing the optical recording material, the optical recording material and other elements are mixed, the mixture is added to a solvent, and the solvent is agitated. It is preferable that this preparation is carried out under a dark illumination such as light from a red lamp in order to prevent the optical recording material from hardening.

The solvent to be used is not limited to specific one, as long as dissolving the optical recording material sufficiently and forming a film of an excellent property. Examples of this solvent include: cellosolve solvent such as methyl cellosolve, ethyl cellosolve, methyl cellosolve acetate or ethyl cellosolve acetate; a propylene glycol solvent such as propylene glycol monomethyl ether, propylene glycol monoethyl ether, propylene glycol monobutyl ether, propylene glycol monomethyl ether acetate, propylene glycol mono ethyl ether acetate, propylene glycol monobutyl ether acetate or dipropylene glycol dimethyl ether; ester solvent such as butyl acetate, amyl acetate, ethyl acetate, butyl acetate, diethyl oxalate, pyruvic acid ethyl, ethyl-2-hydroxybutyrate ethyl acetoacetate acetate, methyl lactate, ethyl lactate or 3-methoxy propionic acid methyl; alcohol solvent such as butanol, heptanol, hexanol, diacetone alcohol or furfuryl alcohol; ketone solvent such as ethyl isobutyl ketone, dimethyl ketone, cyclohexanone, methyl amyl ketone or methyl ethyl ketone; a high polarity solvent such as dimethylformamide or dimethylacetamide-N-methylpyrrolidone; hydrocarbon cyanide solvent such as acetonitrile; a mixed solvent thereof; each of the above solvents to which aromatic hydrocarbon is added; and a carbon hydride halide solvent such as dichloromethane or chloroform. The adding rate of the solvent is 10 to 90% by mass in the total amount of the recording material. Furthermore, it is preferable that the boiling point of the solvent is equal to/less than 100° C.

As for the viscosity of the above coating liquid, it is selected appropriately depending on the coating treatment, but it is typically 0.1 to 50 Ps. In this case, it is preferable that the viscosity is 1 to 30 Ps, especially when the coating liquid is applied with a coater knife such as a doctor knife.

The process in which the coating liquid is applied to the light transmitting substrate 1 may be performed by a dip-coat method. In this case, a coater, rod, coil bar or blade may be used. Use of a coil bar or rod is more preferable, so that a uniform optical information recording layer is formed.

To form the optical information recording layer 3 on the light transmitting substrate 1 by means of injection molding, a double layer or multi-color injection molding may be employed. Alternatively, may be performed, an injection molding process including: the steps of 1) setting the light transmitting substrate 1 within a cavity of a die; 2) closing the die; and 3) allowing the optical recording material to flow into the die. In the above molding process, it is preferable that the optical recording material having a sufficient heat resistance is selected. In addition, after the injection molding, the surface of the medium may be subjected to a surface smoothing treatment such as a polishing treatment.

When the thermo compression bonding is used to form the optical information recording layer 3 on the light transmitting substrate 1, may be carried out, a process including: the steps of 1) preparing a film or sheet of a predetermined thickness beforehand; 2) laminating the film or sheet on the light transmitting substrate 1; 3) setting the light transmitting substrate 2 on the film or the sheet, and 4) heating and pressing the substrate 2 downward. In this process, an important point is that the light transmitting substrates 1 and 2 are arranged parallel to each other. In addition, it needs to be performed at a temperature equal to/more than Tg of the binder contained in the optical recording material.

When the above spin coat process is employed to form the optical information recording layer 3 on the light transmitting substrate 1, may be done, a process including steps of: 1) coating a liquid containing the optical recording material on the light transmitting substrate 1 with a spin coat; 2) drying the liquid; and 3) repeating the above steps until the optical information recording layer 3 is formed to a desired thickness. In this process, an important point is that the rotation number of a disc and the viscosity of the liquid are selected appropriately. If being of a disc or card type, the medium may undergo a surface smoothing treatment with a calender.

### EXAMPLE

The embodiment will be described more concretely by making a comparison between following Example and Comparative example.

### Comparative Example 1

Preparation of Coating Liquid A>

Coating liquid A that contained an optical recording material made up of compositions of the table 1 was prepared by:

a1) measuring, under light from a red ramp, the respective weights of binder, monomer, polymerization inhibitor (contained in the monomer), sensitizing dye and polymerization initiator shown in a table 1;

a2) pouring them to a brown flask;

a3) adding dichloromethane as solvent to the flask; and

a4) stirring the solvent for three hours by a stirrer.

Note that this viscosity was 21 Ps.

TABLE 1

| | COMPOSITION | WEIGHT RATIO |
|---|---|---|
| BINDER | CAB531-1 | 1000 |
| MONOMER | POEA | 920 |
| POLYMERIZATION INHIBITOR | MEHQ | 0.276 |
| SENSITIZING DYE | DEHQ | 0.56 |
| POLYMERIZATION INITIATOR | MBO | 36 |
| | ortho-CL-HABI | 24 |
| SOLVENT | Dichloromethane | 6240 |

Note)
CAB531-1: cellulose acetate butyrate (manufactured by Eastman Chemical Company)
POEA: acrylic acid 2-phenoxyethyl (CasNo. 48145-04-6)
MEHQ: 4-methoxy phenol (CasNo. 150-76-5)
DEAW: cyclopentanone-2, 5-bis[[4-(diethylamino)phenyl]methylene] (CasNo. 38394-53-5)
MBO: 2-mercaptobenzoxazole (CasNo. 2382-96-9) ortho-Cl-HABI: 2,2-bis[ortho-chlorophenyl]-4,4,5,5-tetraphenyl-1,1-biimidazole (CasNo. 1707-68-2)

The coating liquid A was applied to a transparent substrate (TAC, thickness of 100 μm) by a coater on the condition that a clearance (gap length) was 300 μm. Subsequently, a process in which the coating liquid A was applied and then dried was performed twice. Finally, the optical information recording layer of 123 μm thick was formed on the transparent substrate. In addition, a glass substrate of 1 mm thick was stuck on the optical information recording layer.

### Example 1

Preparation of Coating Liquid B>

Coating liquid B that contained an optical recording material made up of compositions of the table 2 was prepared by:

b1) measuring, under light from a red ramp, the respective weights of binder, dye to be faded by acid, acid generator, and sensitizing dye shown in a table 2;

b2) pouring them to a brown flask;

b3) adding solvent to the flask;

b4) stirring the solvent for three hours by a stirrer.

TABLE 2

| | COMPOSITION | WEIGHT RATIO |
|---|---|---|
| BINDER | PC | 1000 |
| DYE BEING FADED | DYE A | 157.5 |
| BY ACID | | |
| ACID GENERATOR | ACID GENERATOR A | 500 |
| SENSITIZING DYE | DYE B | 80 |
| SOLVENT | METHYLENE CHLORIDE | 3250 |
| SOLVENT | ACETONITRILE | 1052.5 |

PMMA: poly methyl methacrylate (manufactured by Aldrich Company, Mw: 996000)
Dye A: quaternary ammonium salt being expressed by the following composition formula (a) 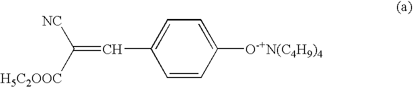
Acid Generator A: diphenyl iodonium exafluorophosphoric acid (CasNo.58109-40-3)
Dye B: Ru complex compound being expressed by the following composition formula (b)

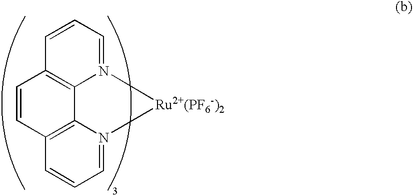

The coating liquid A was applied to a transparent substrate (TAC, thickness of 100 μm) by a coater on the condition that a clearance (gap length) was 300 μm. Subsequently, a process in which the coating liquid B was applied and then dried was performed twice. Finally, the optical information recording layer of 120 μm thick was formed on the transparent substrate. In addition, a glass substrate of 1 mm thick was stuck on the optical information recording layer.

In this optical information recording layer formed of the coating liquid B, the sensitizing dye A on the bright patterns of the moire fringes was excited by a laser, and the excited dye then emitted electrons. The emitted electrons traveled to the acid generator, and the acid generator then generated acid. The coloring agent B was faded by the acid, and its refractivity changed. In this way, the dye on the bright patterns of the moire fringes was faded, whereby the refractivity modulation occurred. Consequently, the hologram was recorded.

<Evaluation>

For each of the optical recording media obtained in Example 1 and Comparative example 1, diffraction efficiency of the medium, and the thickness, Young's modulus and deformation amount of the optical information recording layer were measured by the following methods.

Measurement of Diffraction Efficiency

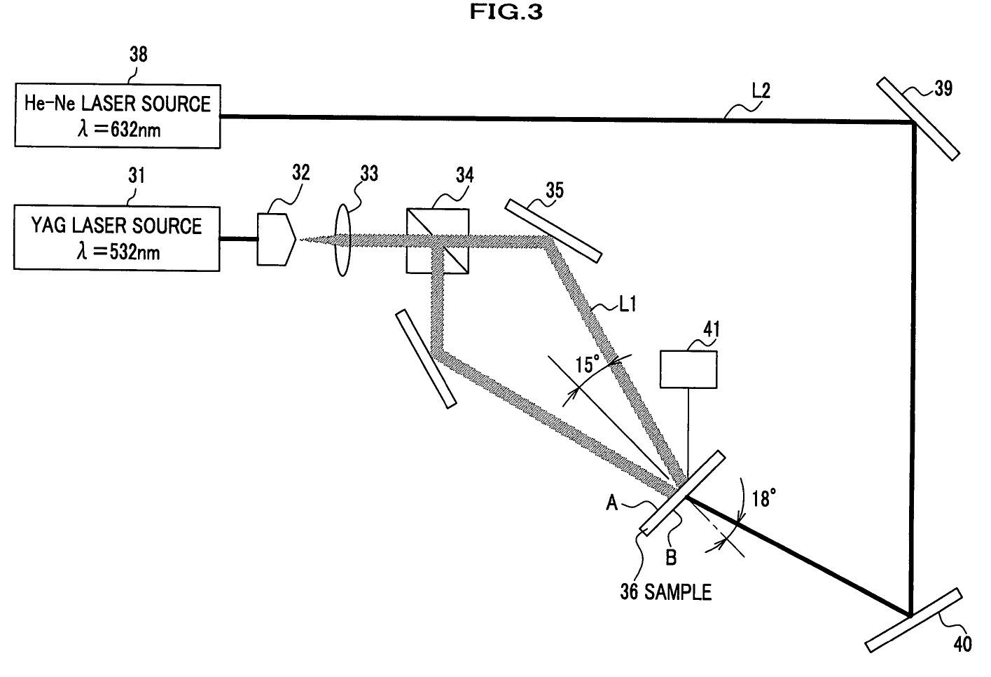

Referring to FIG. 3, YAG laser beam L1 from a YAG laser source 31 was irradiated on a front surface A of an optical recording medium 36 through an object lens 32, lens 33, beam splitter 34 and mirror 35. In this way, saturation exposure recording was carried out, and its condition was as follows:
Incident angle: 15 degrees;
Spot diameter: 8 mmφ;
Light intensity: 3 mW;
Recording energy: 2000 mJ/cm².
   Thereafter, UV light of 100 W was irradiated on the optical recording medium 36 by a xenon lamp for an hour, so that the recorded hologram was fixed.

Next, He—Ne laser light L2 with a wavelength of 633 nm was irradiated on a back surface B of the optical recording medium (sample) 36 from the He—Ne laser source 38 through a mirror 39 and mirror 40 on the condition that the incident angle was 18 degrees. In this state, the variation in the diffraction efficiency with the light exposure was measured. The diffraction efficiency was determined based on the following equation;
Diffraction efficiency (%)=(Diffracted light quantity)/(Incident light quantity)×100
where the diffracted light quantity was the quantity of light emitted from a He—Ne laser, and it was detected by a power meter 41 that was placed on the front surface A of the optical recording medium 36. Moreover, the incident light quantity was the quantity of light which was emitted from the He—Ne laser and which was incident to the back surface B of the optical recording medium 36.
   Thickness of Optical Information Recording Layer

A digital micrometer manufactured by SONY Corporation was used to measure the thickness of the optical information recording layer. First, the whole thickness of the sample was measured. Then, the thickness of the optical information recording layer was determined by subtracting the thicknesses of the transparent and glass substrates from the measured value.

Young's Modulus of Optical Information Recording Layer

The coating liquid A or coating liquid B was applied to a supporting body of 1 μm thick (manufactured by PET), thereby fabricating a specimen of 2 μm thick. Next, the young's modulus of this specimen was measured by a tensile tester (STM-T-50BP, manufactured by BALDWIN Company) at 10%/min. of tension speed under the atmosphere of 23° C. and 70% RH. The Young's modulus of the optical information recording layer was determined by subtracting the Young's modulus of the supporting body from the measured Young's value.

Deformation Amount of Optical Information Recording Layer

A weight of 100 g was mounted for 10 seconds on the surface of the optical recording medium on which the transparent substrate was formed. Thereafter, the deformation of the optical information recording layer was observed with naked eyes when the weight was removed thereof. Note that Tg of the binder was shown in a table 3.

TABLE 3

| | | COMPARATIVE |
|---|---|---|
| | EXAMPLE 1 | EXAMPLE |
| | B | A |
| Young's modulus[MPa] | 5000 | 50 |
| SUPPORTING BODY | TAC/100 μm | TAC/100 μm |
| THICKNESS OF | 120 | 123 |
| OPTICAL INFORMATION | | |
| RECORDING | | |
| LAYER [μM] | | |
| DEFORMATION AMOUNT | NO DEFORMATION | DEFORMED |
| Δdiffraction efficiency [%] | 1 | 10 |
| Tg[°] | 104 | 115 |

As was evident from the table 3, the supporting body of Example 1 was not deformed at all even when the weight was mounted thereon, and its diffraction efficiency did not change around the vicinity of the area where the weight was mounted. In contrast, since being formed of photopolymer, the optical information recording layer of Comparative example 1 was very soft, and it was deformed when the weight was mounted thereon. In addition, the diffraction efficiency was degraded on the deformed portion.

From the aforementioned explanation, those skilled in the art ascertain the essential characteristics of the present invention and can make the various modifications and variations to the present invention to adapt it to various usages and conditions without departing from the spirit and scope of the claims.

What is claimed is:

1. An optical recording medium comprising:
two light transmitting substrates; and
an optical information recording layer to which information is to be recorded with recording light and which is formed between the light transmitting substrates, a thickness of the optical information recording layer being at least 100 μm, the Young's modulus of the optical information recording layer ranging from 1000 MPa to 30000 MPa.

2. The optical recording medium according to claim 1,
wherein each of the light transmitting substrates has a thickness ranging from 50 μm to 1500 μm.

3. The optical recording medium according to claim 2,
wherein one of the light transmitting substrates to which the recording light is irradiated has a thickness of at least 50 μm, and the other of the light transmitting substrates has a thickness of at least 200 μm.

4. The optical recording medium according to claim 1,
wherein each of the light transmitting substrates comprises a film or sheet made of at least one resin selected from a group consisting of polycarbonate, triacetyl-cellulose, cycloolefin polymer, polyethylene terephthalate, polyphenylene sulfide, acrylic resin, methacrylic resin, polystyrene, polychloroethene, epoxy reisn, polyester and amorphous polyolefin.

5. The optical recording medium according to claim 4,
wherein each of the light transmitting substrates is made of polycarbonate.

6. The optical recording medium according to claim 1,
wherein the thickness of the optical information recording layer ranges from 100 μm to 2 mm.

7. The optical recording medium according to claim 1,
wherein the thickness of the optical information recording layer ranges from 500 μm to 1.5 mm.

8. The optical recording medium according to claim 1,
wherein the Young's modulus of the optical information recording layer ranges from 2000 MPa to 20000 MPa.

9. The optical recording medium according to claim 1,
wherein a servo signal recording area is formed on a surface of one of the light transmitting substrates, to which the recording light is not irradiated and which is in contact with the optical information recording layer.

10. The optical recording medium according to claim 1 being a holographic recording optical recording medium.

11. The optical recording medium according to claim 10,
wherein the optical information recording layer is made of a optical recording material of which at least one of refractivity, transmittance, permittivity, reflectivity and absorptivity changes depending on whether patterns of moire fringes formed by irradiation of the recording light are dark or bright.

12. The optical recording medium according to claim 11,
wherein compositions of the optical recording material comprise an optical recording composition including dye for causing refractivity modulation, optical reactant for developing or fading the dye, sensitizing dye for clearing the optical reactant, and binder.

13. The optical recording medium according to claim 1 being a multi-layered optical memory using two-photon absorption.

14. The optical recording medium according to claim 1,
wherein the optical information recording layer is formed by one of multi-layer coating, injection molding, thermo compression bonding and spin coat processes.
